(19) United States
(12) Patent Application Publication
(10) Pub. No.: US 2008/0026154 A1
(43) Pub. Date: Jan. 31, 2008

(54) Polymers and Their Use as Coatings

(76) Inventors: Richard Garfield Jones, Nr Accrington (GB); Claire Louise Bolton, Nr Accrington (GB); John McKay, Nr Arrington (GB); Peter Hargreaves, Nr Accrington (GB)

Correspondence Address: NIXON & VANDERHYE, PC, 901 NORTH GLEBE ROAD, 11TH FLOOR, ARLINGTON, VA, 22203, US

(21) Appl. No.: 11/629,292

(22) PCT Filed: Jun. 16, 2005
(86) PCT No.: PCT/GB05/02357

§ 371 Date: Feb. 1, 2007

(30) Foreign Application Priority Data
Jun. 18, 2004 (GB) 0413707.1

(51) Int. Cl. C08G 69/16; B05D 3/00; C08G 69/48

(52) U.S. Cl. 427/385.5; 106/287.25; 528/322; 528/367

(57) ABSTRACT

A polymer product comprising a plurality of compounds of formula (I): 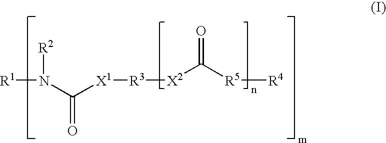 The product can be prepared by polymerising a lactam or lactone in the presence of a urethane diol or polyol. The products are useful in the production of polyurethane coatings.

### FIELD OF THE INVENTION

The present invention relates to urethane-group containing diol or polyol polymer products as well as a process for their production. The polymer products can be used in cross-linking reactions to produce coatings containing carbamate groups, for example polyurethane coatings.

### BACKGROUND OF THE INVENTION

Polyester based polyurethanes are well known and used widely for many applications, including surface coatings. These materials are manufactured from polyester resins, typically produced by reacting difunctional alcohols and difunctional acids to produce hydroxyl functional polyesters, which are then cross-linked with di- or tri-functional isocyanates in order to produce polyurethanes. However, isocyanates are highly dangerous and there is increasing pressure to minimise the use of these materials for environmental, and health and safety reasons.

Various alternatives to isocyanate chemistry are already available but they do not offer the same benefits as the use of isocyanates. For example, melamine-based resins (and similar products such as ureas, benzoguanamine or glycoluril resins) are widely used to cross-link hydroxyl functional polyesters but this often leads to coatings which are too hard, brittle and/or inflexible, particularly when high hydroxyl containing acrylic resins are used.

When the use of free isocyanate is undesirable on health and safety grounds or for technical reasons, it is widely practised to incorporate isocyanate prepolymer or polyisocyanate, either containing free isocyanate functionality or having chemically protected isocyanate (“blocked isocyanate”). However, whilst providing polyurethanes which are flexible and highly chemically resistant, blocked isocyanates are expensive materials and their use is therefore not always cost-effective. Further, even blocked isocyanates are becoming unfavoured from a safety point of view. Alternative routes to polyurethanes are therefore desired which are not detrimental to the properties of the final polyurethane product, but avoid the safety issues connected with isocyanates and blocked isocyanates.

A further problem associated with known isocyanate technology is the restriction in the range of polyurethane materials which can be produced due to the limited number of commercially available starting materials. Many diols and diacids are currently available. For example, diethylene glycol, ethylene glycol, 1,4-butanediol, 1,6-hexanediol and neopentylglycol are typically used along with adipic acid, succinic acid, terephthalic acid and many other diacids. However, commercially available isocyanates are more limited. A new process is therefore desired which enables a broader range of polyurethanes to be produced from commercially available starting materials.

### SUMMARY OF THE INVENTION

The present inventors have developed a new technology which allows polyester based polyurethanes to be manufactured without involving isocyanate reagents. A urethane diol or polyol is used to initiate polymerisation of a lactone or lactam, leading to a novel polyester diol or polyol product containing a urethane linkage. The resulting diol or polyol can then be cross-linked, for example with non-isocyanate cross-linking agents such as melamine, to produce a polyurethane coating.

The technology allows the introduction of urethane groups or carbamate groups into the coating compositions. This means that the beneficial physical properties of coatings produced using isocyanate technology, including flexibility and chemical resistance, are retained but in the complete absence of isocyanate reagents, offering health and safety and environmental benefits and making the process a viable alternative to the use of free or blocked isocyanates. The process is also significantly more cost effective than the use of blocked isocyanates in the production of one-component coating formulations.

The use of the process of the present invention also enables a broader range of polymers to be manufactured than is possible using the isocyanate route since certain diisocyanates, such as ethylene diisocyanate, are not commercially available or easily synthesised, whereas the corresponding urethane diol or polyol precursors can be obtained economically.

The provision of a broader range of polyurethanes will, in turn, provide the skilled person in the art with access to polymers with new and different combinations of properties. This may lead to improvements in the currently known applications such as coatings and adhesives and may further lead to new applications for polyurethanes.

Thus, the present invention provides a polymeric product of the structure (I) 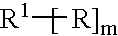
wherein:
R¹ is an aliphatic or aromatic, straight, branched or cyclic group which is unsubstituted or substituted with one or more substituents selected from halogen atoms, C₁-C₁₂ alkoxy, C₁-C₁₂ alkylthio and C₁-C₁₂ alkyl groups;
m is an integer of from 2 to 4;
the side-chains R, may be the same or different and each is a group of formula (II) 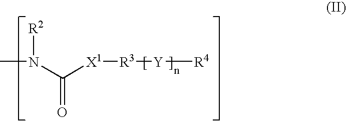
   wherein
each R² is a hydrogen atom or a C₁-C₄ alkyl group;
each X¹ is N or O;
each R³ is the same or different and is a C₂-C₁₂ alkylene, C₂-C₁₂ alkenylene or C₂-C₁₂ alkynylene group, each of which is straight or branched and is unsubstituted or substituted with one or more substituents selected from halogen atoms and C₁-C₁₂ alkoxy and C₁-C₁₂ alkylthio groups;
each R⁴ is —OH or —NH₂;
each n is the number of monomer units Y in each side chain and has an average value of 1 to 50;
the groups Y may be the same or different and Y represents a monomer unit of formula (III): 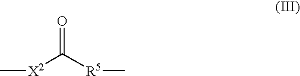
   wherein
each X² is N or O; and
each R⁵ is a C₂-C₁₂ alkylene, C₂-C₁₂ alkenylene or C₂-C₁₂ alkynylene group, each of which is straight or branched and is unsubstituted or substituted with one or more substituents selected from halogen atoms and C₁-C₁₂ alkoxy and C₁-C₁₂ alkylthio groups and wherein one or more non-adjacent, saturated carbon atoms of said alkylene, alkenylene or alkynylene group is optionally replaced with a nitrogen, oxygen or sulfur atom;
the values of R², X¹, R³, n and R⁴ may be the same or different in the different side chains R and the values of X² and R⁵ may be the same or different within each side chain R and may be the same or different in the different side chains R.

The present invention also provides a process for producing the polymeric products of the invention, as depicted below. The process involves initiating the polymerisation of a lactone or lactam with a urethane diol or polyol.

The polymeric products of the invention are useful in the production of polyurethanes. The present invention therefore also provides a process for preparing a polyurethane comprising curing a polymeric product of the invention in the presence of a cross-linking agent, as well as a polyurethane obtained or obtainable thereby.

The polymeric products of the invention are envisaged to be particularly useful in the production of coatings. The invention therefore also provides a coating composition comprising
a) a polymeric product of the invention; and
b) one or more cross-linking agents;
optionally together with one or more components selected from
c) a catalyst;
d) one or more solvents;
e) another polymer or polymers reactive with the cross-linking agent; and
f) one or more chain extenders.

The coating composition of the invention can be used to form a coated article by
i) applying the coating composition to the surface of the article; and
ii) curing said composition to produce a coated article.

The present invention therefore also provides a process for coating an article as set out above as well as a coated article obtained or obtainable thereby.

The coatings produced in accordance with the present invention have the advantages of flexibility and chemical resistance that are usually associated with coatings produced using isocyanates. In addition, the polyurethanes and coatings of the invention have enhanced phase separation within the polyurethane structure. Previously known polyurethanes have a random separation of urethane groups through the backbone of the polymer, leading to the disruption of phase separation. This effect is described further in “Polyurethane” 2^{nd} edition (Gunter Oertel, published Carl Hanser Verlag, 1994) pages 37 to 46. In contrast, the polyurethanes of the present invention have single urethane groups which are uniformly separated by polyester phases. The polyurethanes thus display good phase separation of hard and soft segments, which in turn may lead to improvements in the elastomeric properties of the polyurethane.

### DETAILED DESCRIPTION OF THE INVENTION

As used herein and unless otherwise defined, a C₁-C₁₂ alkyl or C₂-C₁₂ alkylene group is typically a C₁-C₈ alkyl or C₂-C₈ alkylene group which is either straight or branched, and is preferably straight. Examples of C₁-C₈ alkyl and C₂-C₈ alkylene groups include methyl, ethyl, n-propyl, n-butyl, n-pentyl, n-hexyl, ethylene, n-propylene, n-butylene, n-pentylene and n-hexylene. A C₁-C₁₂ alkoxy or alkylthio group is typically a C₁-C₁₂ alkyl group as defined above attached to an oxygen or sulfur atom respectively.

As used herein and unless otherwise defined, a C₂-C₁₂ alkenyl or C₂-C₁₂ alkenylene group is a C₂-C₁₂ hydrocarbon group or moiety containing one or more double bonds. A C₂-C₁₂ alkenyl or C₂-C₁₂ alkenylene group is typically a C₂-C₈ alkenyl or C₂-C₈ alkenylene group which is either straight or branched, and is preferably straight. Examples of C₂-C₈ alkenyl and alkenylene groups include ethyenyl, n-propenyl, ethenylene, n-propenylene, n-butenylene, n-pentenylene and n-hexenylene.

As used herein and unless otherwise defined, a C₂-C₁₂ alkynyl or C₂-C₁₂ alkynylene group is a C₂-C₁₂ hydrocarbon group or moiety containing one or more triple bonds. A C₂-C₁₂ alkynyl or C₂-C₁₂ alkynylene group is typically a C₂-C₈ alkynyl or C₂-C₈ alkynylene group which is either straight or branched, and is preferably straight. Examples of C₂-C₈ alkynyl and alkynylene groups include ethynyl, n-propynyl, ethynylene, n-propynylene, n-butynylene, n-pentynylene and n-hexynylene.

As used herein, a halogen atom is a fluorine, chlorine or bromine atom.

As used herein, an alkyl group or alkylene moiety wherein one or more non-adjacent, saturated carbon atoms of said alkyl group is replaced with a nitrogen, oxygen or sulfur atom, is typically a group of formula —(C₁-C₄ alkylene)-Y—(C₁-C₄ alkyl(ene)) wherein Y is N, O or S. Examples include —(CH₂)ₙ—O—(C₁-C₂ alkyl(ene)), —(CH₂)ₙ—NH—(C₁-C₂ alkyl(ene)) and —(CH₂)ₙ—S—(C₁-C₂ alkyl(ene)), wherein each n is the same or different and is 1 or 2.

The group R¹ of the compounds of formula (I) is typically derived from an aliphatic or aromatic polyamine compound having m amine groups, wherein m is as defined above, in which the amine groups are replaced with the substituents —N(R²)C(O)—X¹—R³—Yₙ—R⁴ as depicted in formula (I). Thus, a wide variety of different aliphatic and aromatic groups can be used as the group R¹.

Examples of suitable R¹ groups include C₁-C₁₂ alkyl, C₂-C₁₂ alkenyl and C₂-C₁₂ alkynyl groups, one or more non-adjacent, saturated carbon atoms of said alkyl, alkenyl or alkynyl groups optionally being replaced with a nitrogen, oxygen or sulfur atom. Further possible R¹ groups include groups of formula R⁶, (C₁-C₄ alkyl)-R⁶, R⁶—(C₁-C₄ alkyl), (C₁-C₄ alkyl)-R⁶—(C₁-C₄ alkyl) or R⁶—(C₁-C₂ alkylene)-R⁶, wherein R⁶ is a C₆-C₁₀ aryl or C₃-C₁₀ carbocyclyl group, or a 5- to 7-membered heteroaryl or heterocyclyl group containing one, two or three atoms selected from nitrogen, oxygen and sulfur.

When R⁶ is a C₆-C₁₀ aryl group it is typically phenyl or naphthyl. When R⁶ is a C₃-C₁₀ carbocyclyl group, it is typically a C₃-C₈ single ring cycloalkyl compound, for example cyclopentyl or cyclohexyl, or a C₈-C₁₀ fused ring system, for example decalinyl. When R⁶ is a 5- to 7-membered heteroaryl group it is typically pyridyl, thienyl, furyl or pyrrolyl. When R⁶ is a 5- to 7-membered heterocyclyl group it is typically tetrahydrofuranyl, piperidinyl or pyrrolidinyl. Preferably R⁶ is a C₆-C₁₀ aryl or C₃-C₁₀ carbocyclyl group. Most preferably, R⁶ is phenyl, naphthyl, cyclopentyl, cyclohexyl or decalinyl.

Preferred R¹ groups include C₂-C₄ alkyl and groups of formula R⁶, (C₁-C₂ alkyl)-R⁶, R⁶—(C₁-C₂ alkyl), (C₁-C₂ alkyl)-R⁶—(C₁-C₂ alkyl) or R⁶—(C₁-C₂ alkylene)-R⁶, wherein R⁶ is phenyl, naphthyl, cyclopentyl, cyclohexyl, or decalinyl. More preferred groups R¹ include ethylene, n-propylene, n-butylene, phenyl, naphthyl, methylbenzyl, decalin, cyclohexyl-(CH₂)-cyclohexyl and phenyl-(CH₂)-phenyl.

The group R¹ is substituted with 2, 3 or 4 groups of formula —N(R²)C(O)—X¹—R³—Yₙ—R⁴ as depicted in formula (I), thus m is 2, 3 or 4. These substituents may be located at any position on the group R¹ including, where relevant, on either the cyclic or the linear part of the group. R¹ is optionally further substituted with one or more, such as 1, 2 or 3 further substituents. These further substituents are typically selected from halogen atoms and C₁-C₄ alkoxy, C₁-C₄ alkylthio and C₁-C₄ alkyl groups.

Each R², which may be the same or different, is typically a methyl or ethyl group or a hydrogen atom. R² is preferably a hydrogen atom.

Each R³ is typically a straight or branched C₂-C₁₂ alkylene group, preferably a C₂-C₈, more preferably a C₂-C₆ or a C₂-C₃ alkylene group. Typically, R³ is a straight-chain alkylene group. R³ is typically unsubstituted or substituted with 1, 2 or 3 substituents selected from halogen atoms and C₁-C₄ alkoxy and C₁-C₄ alkylthio groups. Preferably R³ is unsubstituted. Examples of typically R³ groups include ethylene and n-propylene, in particular ethylene (—CH₂—CH₂—).

Each R⁴ is typically OH.

Each X¹ and each X² is typically O.

Each n may be the same or different and typically has a value from 1 to 25, for example from 2 to 10, such as from 2 to 5. Preferably the average values of n are the same and are about 3.

Each R⁵, which may be the same or different, is typically a straight or branched C₂-C₁₂ alkylene group, preferably a C₂-C₈, more preferably a C₃-C₆, for instance a C₅ alkylene group. Typically, R⁵ is a straight-chain alkylene group. R⁵ is typically unsubstituted or substituted with 1, 2 or 3 substituents selected from halogen atoms and C₁-C₄ alkoxy and C₁-C₄ alkylthio groups. Preferably R⁵ is unsubstituted. Examples of typical R⁵ groups include —(CH₂)ₚ— wherein p is 3, 4, 5 or 6, in particular 5.

Typically m is 2 or 3, preferably 2.

Preferred polymeric products of the invention have the structure (IV) 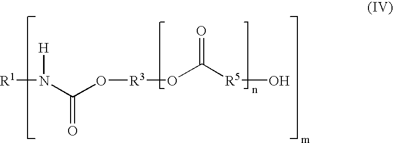
wherein
R¹ is an aliphatic or aromatic, straight, branched or cyclic group which is unsubstituted or substituted with one or more substituents selected from halogen atoms, C₁-C₁₂ alkoxy, C₁-C₁₂ alkylthio and C₁-C₁₂ alkyl groups, or R¹ takes one of the preferred meanings set out above;
each R³ is the same or different and is a straight or branched C₂-C₆ alkylene group which is unsubstituted or substituted with 1, 2 or 3 substituents selected from halogen atoms and C₁-C₄ alkoxy and C₁-C₄ alkylthio groups;
each R⁵ is the same or different and is a straight or branched C₃-C₆ alkylene group, which is unsubstituted or substituted with 1, 2 or 3 substituents selected from halogen atoms and C₁-C₄ alkoxy and C₁-C₄ alkylthio groups;
each value of n is the same or different and is on average from 2 to 10; and
m is 2 or 3.

Particularly preferably, in formula (IV), R³ is —CH₂—CH₂— and R⁵ is —(CH₂)₅—.

The polymeric products of the present invention are typically produced by a polymerisation reaction of a lactone or lactam with a urethane diol or polyol. The products therefore contain a number of individual compounds each of formula (I) or (IV). Typically, the polymeric product comprises a number of different compounds of formula (I) or (IV), each of which can be prepared by polymerisation of the same starting materials. Thus, a polymeric product may, for example, contain a number of compounds which differ only in terms of their values of m and n in formula (I) or (IV).

The polymeric products of the invention typically have weight average molecular weights (Mw) in the region of 500 to 3000 and number average molecular weights (Mn) in the region of 500 to 2500 when measured by GPC with reference to a polystyrene standard.

The polymeric products of the invention can be prepared by polymerising a lactone or lactam (VI) in the presence of a urethane dial or polyol compound (V), in accordance with Scheme I.

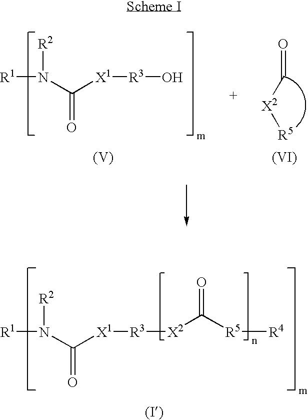

In the above Scheme I, R¹, R², R³, R⁴, R⁵, X¹, X², n and m have the meanings set out above. The reaction is typically carried out in the presence of a Lewis acid catalyst or at a pH of less than 7 and at a temperature of approximately 50-150° C. In the polymerisation process of the present invention, the polymerisation can be promoted by any type of catalyst known in the art. Particularly attractive are metal oxides, halides or carboxylates, the metals of which contain free p, d or f orbitals of a favourable energy, e.g. Mg, Ti, Zr, Zn, Sn, Al, Y, La, Hf and rare earth atoms such as Sm, in the presence of protic species such as alcohols, amines, thiols and water.

It is however preferred that the polymerisation process employs 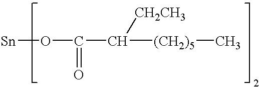
(herein referred to as stannous octoate) as a catalyst.

As will be readily understood (and is capable of being determined) by one skilled in the art, the precise concentration of the catalyst to be employed in the process of the present invention may be varied as needed to obtain the polymer which is desired to be obtained thereby.

If desired, two or more different compounds of formula (V) and/or two or more different compounds of formula (VI) may be used as starting materials. Typically, however, a single compound (V) and a single compound (VI) are used.

The lactone or lactam (VI) should be present in sufficient quantities to provide the desired values of n in the product (I). For example, when m=2 and each n=about 3, six equivalents of lactone or lactam (VI) are required for each equivalent of compound (V). At least two equivalents of lactone or lactam (VI) must be used in any case.

It is noted that the reaction is carried out at relatively low temperatures, in particular when compared with typical temperatures for carrying out a conventional polyesterification, i.e. up to 240° C., typically from 220 to 240° C. The use of low temperatures enables urethane diols or polyols to be used without discolouration of the final polymer. It is thought that urethane diols or polyols degrade when subjected to higher temperatures and therefore cannot be conveniently used in conventional polyesterifications.

The above reaction can, if desired, be carried out using an enzymatic polymerisation process such as that described in GB-B-2 272 904 and EP-B-0 670 906.

The lactams and lactones (VI) are typically available commercially. For example, a preferred compound of formula (VI) is caprolactone which is widely available. The urethane diols or polyols of formula (V) can be produced from the corresponding di- or poly-amines of formula (VII) by reaction with a cyclic carbonate or oxazolone of formula (VIII), as is depicted in Scheme II.

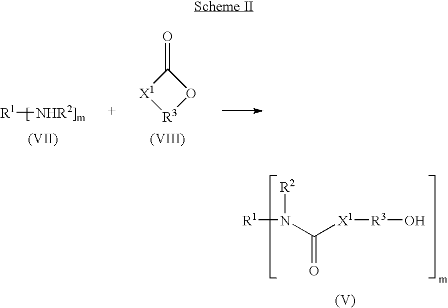

In the above Scheme II, R¹, R², R³, X¹ and m have the meanings set out above. This reaction can be carried out in an inert organic solvent such as toluene and at a temperature of approximately 50° C., or in accordance with any techniques known in the art. The di- or polyamines of formula (VII) and the carbonates or oxazolones of formula (VIII) are commercially available or can be produced by techniques well known to the skilled chemist. An example of a commercially available diamine of formula (VII) is Lonzacure DETDA 80 from Lonza Ltd, Switzerland. This product is a mixture of about 80% 3,5-diethyltoluene-2,4-diamine and about 20% 3,5-diethyltoluene-2,6-diamine. The use of this starting material therefore leads to a mixture of polymeric products of the formula 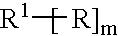
wherein the R¹ group is derived from the 2,4- and the 2,6-isomers.

The polymeric products of the invention can be further reacted using known techniques to produce cured polyurethanes. The process comprises curing a polymeric product of the invention in the presence of a cross-linking agent. Typically, the polymer products are combined with a cross-linking agent and one or more solvents, optionally together with one or more chain extenders, such as polyols or polyamines, and a catalyst system. Further polymer(s) reactive with the cross-linking agent(s) may also be added. The composition thus produced is subsequently cured to produce a final polyurethane product.

Suitable cross-linking agents are known in the art. Preferred cross-linking agents are non-isocyanate containing components such as aminotriazine compounds, in particular melamine, ureas, benzoguanamine or glycoluril; the resins can be alkylated or partially alkylated. Such resins and their chemistry are described in “Organic Coatings Science and Technology” 2^{nd} Edition (edited by Wicks, Jones and Papas), Pub. Wiley Interscience, 1999. Chapter 9 p 162-179 is devoted entirely to these resins. Melamine type cross-linkers are, for instance, manufactured by Cytec (www.cytec.com). However, isocyanate and blocked isocyanate cross-linking agents can be employed if desired. Suitable catalyst systems, solvents and chain extenders will also be well known to the skilled person in the art.

The polymer products of the invention are particularly useful in the production of polyurethane coatings, for example clear coatings for the automobile industry and coil coatings. An article is coated by (i) applying a coating composition containing the polymer products of the invention to the article to be coated, and (ii) curing the applied coating. The application and curing steps can be carried out by techniques generally known in the art. For example, the curing step is typically carried out by heating to approximately 150° C.

The coating compositions of the invention comprise (a) the polymer product of the invention, (b) one or more cross-linking agents, optionally (c) a catalyst, optionally (d) one or more solvents, optionally (e) another polymer or polymers reactive with the cross-linker (e.g. a hydroxy-functional acrylic polymer) and optionally (f) one or more chain extenders (for instance amino-functional chain extenders such as diethyl toluene diamine and hydroxy-functional chain extenders such as butane diol). Preferred coating compositions comprise (a) the polymer product of the invention, (b) one or more cross-linking agents and (d) one or more solvents. Further preferred coating compositions comprise (c) a catalyst in addition to components (a), (b) and (d). Suitable coating composition formulations are known in the art and are described, for example, in “Organic Coatings Science and Technology” 2^{nd} Edition (edited by Wicks, Jones and Papas), Pub. Wiley Interscience, 1999, see in particular page 4.

Whilst the polymer products of the invention are particularly useful in the production of coatings, other uses can also be envisaged. For example, the polymer products can be employed as adhesives, foams and moldings.

### EXAMPLES

### Example 1

### Preparation of Urethane Containing Diol

Ethylene carbonate (160 g-1.82 moles) and toluene (200 g) were stirred together and heated to 50° C., creating a homogeneous mixture. Ethylene diamine (54.6 g to 0.91 moles) was added dropwise, maintaining the temperature below 60° C. The reaction mixture was separated into two phases and a white solid separated from the reaction mixture. Toluene was removed by evaporation yielding 208 g of a white powder, mp 92-93° C.

The white powder (70 g) was charged to a reactor, followed by caprolactone (202.9 g) and heated, with stirring, to 110° C. 0.1 g of stannous octoate was added and the consumption of caprolactone monitored by thin layer chromatography. Reaction temperature was maintained at 110-120° C., with subsequent additions of stannous octoate as required to maintain progress of reaction. When all caprolactone was consumed, the reaction was cooled and the contents discharged. On cooling the material became a waxy solid with the following characteristics:

Free caprolactone—1.8%

Mp 1505

Mw 1572

Mn 1315

OHv 134.2 mg KOH/g

### Example 2

### Preparation of Urethane Containing Diol

1,6-Hexanediamine (91.8 g-0.79 moles) and toluene (200 g) were stirred together and heated to 50° C., creating a homogeneous mixture. Ethylene carbonate (140 g-1.59 moles) was added dropwise, maintaining the temperature below 60° C. The reaction mixture was separated into two phases and a white solid seperated from the reaction mixture. Toluene was removed by evaporation yielding 228.1 g of a white powder mp 92° C.

The white powder (40 g) was charged to a reactor, followed by caprolactone (94.3 g) and heated, with stirring, to 120° C. 0.1 g of stannous octoate was added and the consumption of caprolactone monitored by thin layer chromatography. Reaction temperature was maintained at 110-120° C., with subsequent additions of stannous octoate as required to maintain progress of reaction. When all caprolactone was consumed, the reaction was cooled and the contents discharged. On cooling the material became a waxy solid with the following characteristics:

Mp 1933

Mw 2042

Mn 1431

OHv 107.8 mg KOH/g

### Example 3

### Curing of Urethane Containing Diol of Example 1

A coating formulation was prepared by mixing together the following components:

| | |
|---|---|
| Material prepared according to Example 1 | 9.27% |
| Desmophen A870 (hydroxyfunctional acrylic polyol | 38.32% |
| available from Bayer) | |
| Cymel 303 (melamine based crosslinking agent | 13.53% |
| available from Cytec) | |
| Nacure 2530 (catalyst, available from King industries) | 0.78% |
| Triethanolamine | 0.40% |
| Methoxypropylacetate (solvent) | 18.84% |
| Methoxypropanol (solvent) | 18.84% |

### Example 4

### Curing of Urethane Containing Diol of Example 2

A coating formulation was prepared by mixing together the following components:

| | |
|---|---|
| Cymel 303 (melamine based crosslinking agent available from | 13.00% |
| Cytec) | |
| Cycat 4040 (catalyst, available from Cytec) | 0.32% |
| Material prepared according to example 2 | 42.26% |
| Methoxypropanol (solvent) | 16.25% |
| Methoxypropylacetate (solvent) | 28.17% |

The formulations of Examples 3 and 4 were coated onto panels as follows:

| | |
|---|---|
| Panels 1, 4 and 5: | 60 μm wet film thickness on aluminium |
| Panel 2: | 200 μm wet film thickness on glass |
| Panel 3: | 50 μm wet film thickness on tinplated steel |

The coatings were then cured at 140° C. for 30 mins, giving a tack free continuous film.

The cured coatings showed the following characteristics (test methods described below):

| | | Example 3 | Example 4 |
|---|---|---|---|
| Panel 1 | MEK Rubs | >250 | 45 |
| Panel 2 | Koenig hardness (seconds) | 53 | 38 |
| Panel 3 | Mandrel Bend | Passed 3 mm | Passed 3 mm |
| Panel 4 | Adhesion (cross cut adhesion | 3 | 3 |
| | test) | | |
| Panel 5 | Pencil Hardness | 9H | 4H |

The coatings showed a combination of good flexibility, solvent resistance, adhesion and hardness and demonstrates that the urethane containing diol of the invention is suitable for the application.

### Comparative Example 5

As comparative examples the following formulations were prepared:

| | 5A | 5B | 5C |
|---|---|---|---|
| Blocked Isocyanate Trixene | 5.18% | 0.00% | 0.00% |
| BI7982 (note 1) | | | |
| Desmophen A870 | 48.52% | 45.82% | 36.95% |
| CAPA 2100 | 0.00% | 0.00% | 10.7% |
| (hydroxyfunctional | | | |
| polycaprolactone) | | | |
| Cymel 303 | 13.67% | 15.24% | 13.05% |
| Nacure 2530 | 0.80% | 0.80% | 0.80% |
| DBTL | 0.25% | 0.00% | 0.00% |
| triethanolamine | 0.40% | 0.40% | 0.40% |
| methoxypropylacetate | 15.68% | 18.87% | 19.05% |
| Methoxypropanol | 15.68% | 18.87% | 19.05% |

(note 1)
Trixene BI7982 is a 70% solids 3,5-dimethylpyrazole blocked HDI trimer in methoxypropanol

The formulations were coated onto panels in the same manner as described for Examples 3 and 4 and cured at 140° C. for 30 mins.

The cured coatings showed the following characteristics (test methods are described below):

| | Panel No. | 5A | 5B | 5C |
|---|---|---|---|---|
| MEK Rubs | 1 | >250 | 100 | 150 |
| Koenig hardness | 2 | 92 | 87 | 37 |
| (seconds) | | | | |
| Mandrel Bend | 3 | Passed 6 mm | Passed 6 mm | Passed 3 mm |
| Adhesion | 4 | 3 | 4 | 2 |
| Pencil Hardness | 1 | 8H | 8H | 9H |

Comparative Example 5A is an example of an acrylic based coating cured with both melamine and blocked isocyanate, representative of the current art for preparation of 1-pack heat curable coating.

Comparative Example 5B shows the effect of not including an isocyanate/urethane component in the formulation.

Comparative Example 5C shows the effect of incorporating polymerised caprolactone without additional urethane groups. These coatings provide flexibility, but at the expense of MEK resistance.

### Example 6

Polymer products were prepared using substantially the same process as is set out in Example 1, except that the nature of the amines used, and the amounts of ethylene carbonate and caprolactone used, were as set out in the table below. Melting point and molecular weight measurements were taken for each polymer product (test methods are described below).

| | moles | moles | | | | |
|---|---|---|---|---|---|---|
| | ethylene | capro- | | | | polydis- |
| starting amine | carbonate | lactone | MP | MW | MN | persity |
| Ethylene diamine | 2 | 2 | 810 | 823 | 570 | 1.444 |
| Ethylene diamine | 2 | 6 | 1598 | 1672 | 1175 | 1.423 |
| Ethylene diamine | 2 | 10 | 2274 | 2212 | 2274 | 1.393 |
| Hexamethylene | 2 | 2 | 1017 | 1060 | 594 | 1.783 |
| diamine | | | | | | |
| Hexamethylene | 2 | 6 | 2088 | 2133 | 1021 | 2.089 |
| diamine | | | | | | |
| Hexamethylene | 2 | 10 | 3062 | 3059 | 2270 | 1.348 |
| diamine | | | | | | |
| 1,3-cyclohexane | 2 | 2 | 909 | 1001 | 842 | 1.189 |
| bis(methylamine) | | | | | | |
| 1,3-cyclohexane | 2 | 6 | 1921 | 2113 | 1443 | 1.465 |
| bis(methylamine) | | | | | | |
| 1,3-cyclohexane | 2 | 10 | 2710 | 2562 | 1737 | 1.475 |
| bis(methylamine) | | | | | | |

Test Methods
“MEK Rubs” A ball of cotton wool is soaked in methylethyl ketone (butan-2-one). The cotton wool is manually rubbed backwards and forwards over the surface of the coating under test, exerting the maximum pressure possible. Each backward and forward cycle is one “double rub”. The surface is rubbed continuously (re-soaking the cotton after 50 cycles), observing any deterioration in the surface (for instance scratching, marking or dissolution of the coating) up to a maximum of 250 double rubs. (In the coatings tested in the present examples the number of double rubs is recorded on penetration through to the coating substrate.)
“Koenig hardness” ASTM 4366
“Mandrel Bend” AS 3900 E1
“Adhesion” ISO cross-cut adhesion test, BS 3900 E6
“Pencil hardness” ASTM D3363/92A
Molecular weights Measurements carried out using a Polymer Labs Ltd 30 cm×7.5 mm, 1000A (5 μm pore size), using a Waters 410 differential refractive index detector. Mobile phase is Tetrahydrofuran, flow rate 10.0 ml/min. Molecular weights are determined by reference to certified polystyrene standards, supplied by Polymer Labs Ltd, in the molecular weight range 19880 to 925.

1. A polymeric product of the structure (I) 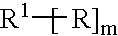
wherein:
R¹ is an aliphatic or aromatic, straight, branched or cyclic group which is unsubstituted or substituted with one or more substituents selected from halogen atoms, C₁-C₁₂ alkoxy, C₁-C₁₂ alkylthio and C₁-C₁₂ alkyl groups;
m is an integer of from 2 to 4;
the side-chains R, may be the same or different and each is a group of formula (II) 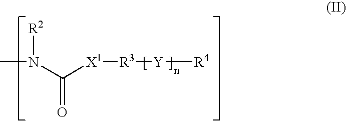
wherein
each R² is a hydrogen atom or a C₁-C₄ alkyl group;
each X is N or O;
each R³ is the same or different and is a C₂-C₁₂ alkylene, C₂-C₁₂ alkenylene or C₂-C₁₂ alkynylene group, each of which is straight or branched and is unsubstituted or substituted with one or more substituents selected from halogen atoms and C₁-C₁₂ alkoxy and C₁-C₁₂ alkylthio groups;
each R⁴ is —OH or —NH₂;
each n is the number of monomer units Y in each side chain and has an average value of 1 to 50;
the groups Y may be the same or different and Y represents a monomer unit of formula (III): 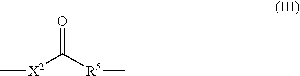
wherein
each X² is N or O; and
each R⁵ is a C₂-C₁₂ alkylene, C₂-C₁₂ alkenylene or C₂-C₁₂ alkynylene group, each of which is straight or branched and is unsubstituted or substituted with one or more substituents selected from halogen atoms and C₁-C₁₂ alkoxy and C₁-C₁₂ alkylthio groups and wherein one or more non-adjacent, saturated carbon atoms of said alkylene, alkenylene or alkynylene group is optionally replaced with a nitrogen, oxygen or sulfur atom;
the values of R², X¹, R³, n and R may be the same or different in the different side chains R and the values of X² and R⁵ may be the same or different within each side chain R and may be the same or different in the different side chains R.

2. A polymeric product according to claim 1
wherein R¹ is a C₁-C₁₂ alkyl, C₂-C₁₂ alkenyl or C₂-C₁₂ alkynyl group, one or more non-adjacent, saturated carbon atoms of said alkyl, alkenyl or alkynyl groups optionally being replaced with a nitrogen, oxygen or sulfur atom, or R¹ is a group of formula R⁶, (C₁-C₄ alkyl)-R⁶, R⁶—(C₁-C₄ alkyl), (C₁-C₄ alkyl)-R⁶—(C₁-C₄ alkyl) or R⁶—(C₁-C₂ alkylene)-R⁶, wherein R⁶ is a C₆-C₁₀ aryl or C₃-C₁₀ carbocyclyl group, or a 5- to 7-membered heteroaryl or heterocyclyl group containing one, two or three atoms selected from nitrogen, oxygen and sulfur, and
wherein R is unsubstituted or substituted with 1, 2 or 3 substituents selected from halogen atoms and C₁-C₄ alkoxy, C₁-C₄ alkylthio and C₁-C₄ alkyl groups.

3. A polymeric product according to claim 1, wherein each R² is hydrogen; each R³ is a straight or branched C₂-C₆ alkylene group which is unsubstituted or substituted with 1, 2 or 3 substituents selected from halogen atoms and C₁-C₄ alkoxy and C₁-C₄ alkylthio groups; and each R⁵ is a straight or branched C₃-C₆ alkylene group, which is unsubstituted or substituted with 1, 2 or 3 substituents selected from halogen atoms and C₁-C₄ alkoxy and C₁-C₄ alkylthio groups.

4. A polymeric product according to claim 1 wherein each X¹ and each X² is O.

5. A polymeric product according to claim 1 wherein m is 2 or 3.

6. A polymeric product according to claim 1 wherein each n has an average value up to 25.

7. A polymeric product according to claim 1 having the structure (IV) 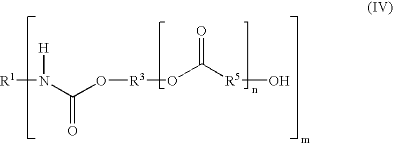
wherein
R¹ is as defined in claim 1;
m is 2 or 3;
the groups R³ are the same or different and each is a straight or branched C₂-C₆ alkylene group which is unsubstituted or substituted with 1, 2 or 3 substituents selected from halogen atoms and C₁-C₄ alkoxy and C₁-C₄ alkylthio groups;
the groups R⁵ are the same or different and each is a straight or branched C₃-C₆ alkylene group, which is unsubstituted or substituted with 1, 2 or 3 substituents selected from halogen atoms and C₁-C₄ alkoxy and C₁-C₄ alkylthio groups;
the values of n are the same or different and each has an average value of from 2 to 10.

8. A polymeric product according to claim 1 wherein R³ is a group of formula —CH₂—CH₂— and R⁵ is a group of formula —(CH₂)₅—.

9. A process for preparing a polymeric product as defined in claim 1, which process comprises reacting one equivalent of a urethane diol or polyol of formula (V). 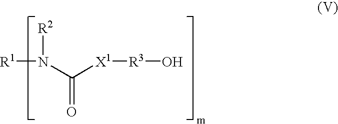
wherein R¹, R², R³, m and X¹ are as defined in claim 1, with at least two equivalents of a compound of formula (VI) 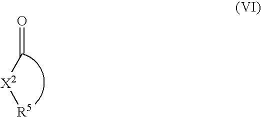
wherein R⁵ and X² are as defined in claim 1.

10. A coating composition comprising
(a) a polymeric product as defined in claim 1; and
(b) one or more cross-linking agents;
optionally together with one or more components selected from
(c) a catalyst;
(d) one or more solvents;
(e) another polymer or polymers reactive with the cross-linking agent; and
(f) one or more chain extenders.

11. A process for coating an article which comprises
(i) applying a coating composition as defined in claim 10 to the surface of said article; and
(ii) curing said composition to produce a coated article.

12. A coated article obtained or obtainable by the process of claim 11.

13. A process for preparing a polyurethane, which process comprises curing a polymeric product as defined in claim 1 in the presence of a cross-linking agent.

14. A polyurethane obtained or obtainable by the process of claim 13.

15. (canceled)
